(19) United States
(12) Patent Application Publication
(10) Pub. No.: US 2012/0070529 A1
(43) Pub. Date: Mar. 22, 2012

(54) MOLDING DEVICE WITH FLUID CIRCUIT(S)

(75) Inventors: Nicolas Rousseau, Octeville-Sur-Mer (FR); Marc Mouchelet, Octeville-Sur-Mer (FR)

(73) Assignee: SIDEL PARTICIPATIONS, OCTEVILLE-SUR-MER (FR)

(21) Appl. No.: 13/322,861

(22) PCT Filed: May 21, 2010
(86) PCT No.: PCT/FR2010/050994

§ 371 Date: Nov. 28, 2011

(30) Foreign Application Priority Data
May 29, 2009 (FR) 09 53563

(51) Int. Cl. B29C 49/64

(52) U.S. Cl. 425/526

(57) ABSTRACT

A molding device having two half-mods that have at least one inner circuit for the circulation of a suitable fluid, such as a coolant or otherwise. The half-molds are hinged on a same shaft by the bearings thereof and the shaft, which is fixed, is provided with bores provided for receiving and returning a fluid and for interacting with rotary fluid seals connected to the half-mold to which the bores are associated. The rotary fluid seals are formed directly at the bearings of the half-mold(s).

The present invention relates to a molding device for manufacturing containers by blow-molding or stretch blow-molding, starting from preforms made of thermoplastic material and, more particularly, it relates to the organization of circuit(s) arranged in this molding device in order to establish a circulation of fluid(s).

This molding device comprises a mold formed in particular of two half-molds that are joined together, by means of their bearing, by a shaft capable of allowing them to rotate between a closed position and an open position and this fluid circulation in the walls of these half-molds can relate to various functions such as, for example, the thermal control of the wall(s) of said mold, but it can also relate to the pressure balancing provided in the molding cavity.

Document U.S. Pat. No. 6,447,281, for example, describes a mold arrangement that makes it possible to establish thermal control of the walls of the mold, which thermal control is carried out by means of a coolant conveyed to said walls by channels that form an inner circuit. This circuit is fed by pliable, or flexible, pipes that are connected to the inlet and outlet thereof.

These different supply and return pipes for the fluid, associated with each half-mold, are subjected to the same movements as the half-molds, i.e. to repeated closing and opening movements, these movements taking place at higher and higher rates.

These movements of the hoses, under sometimes harsh temperature conditions, cause fatigue and rapid wear of said hoses with, of course, significant risks of bursting. These risks of bursting mean that these hoses present a serious danger for the operators and that they can also, if they burst, cause great damage to the mold carrier unit and the whole environment of the blow-molding machine.

These hoses are also bulky around the mold and they tend to hinder the opening of the half-molds. On another level, and despite the use of conspicuous and distinct colours depending on the type of fluid, the presence of all of these hoses is far from ideal on a purely aesthetic level.

The present invention proposes a solution to these problems, which are linked to the use of hoses to supply the half-molds of a blow-molding or stretch blow-molding machine.

The molding device according to the invention has a particularly simple and attractive appearance that makes good use of the current configurations of these molding devices; the cost of fitting, the safety of the operators and the installation in general, and the maintenance of this equipment of the molding device according to the invention, are completely different from the prior solutions.

The molding device according to the invention is installed on the frame of a mold carrier unit that is positioned on the carousel of a blow-molding or stretch blow-molding machine and it comprises a mold carried by said frame, which mold is formed in particular of two half-molds that are joined together by a single shaft on which they are hinged by means of bearings capable of allowing them to rotate between a closed position and an open position, and at least one of these half-molds comprises channels that form an inner circuit for the circulation of a suitable fluid, which molding device comprises, on the one hand, a hinge shaft that is fixed relative to said frame of the mold carrier unit and that is provided with bores provided for receiving and returning the fluid and, on the other hand, rotary fluid seals connected to the half-mold with which they are associated, which seals are mounted rotating on said hinge shaft and interact with its bores for supplying said inner circuit, whether they are half-molds forming part of a mold commonly called a “book mold” or of a mold commonly called a “tulip mold”.

According to a first embodiment of the invention, the molding device comprises rotary fluid seals that are formed directly on the bearings of the half-mold(s), as applicable.

According to another embodiment of the invention, the molding device comprises rotary fluid seals assembled on at least one of the half-molds, which rotary seals are constituted by a ring associated with said half-mold by means of arms, which ring interacts with an extension of the hinge shaft that extends beyond the footprint of the mold, and this ring, with its arm, is provided with channels that connect the bores of said hinge shaft to the channels of the inner circuit of said half-mold.

The invention will also be described in detail by means of the following description and the attached drawings, given by way of illustration and in which:

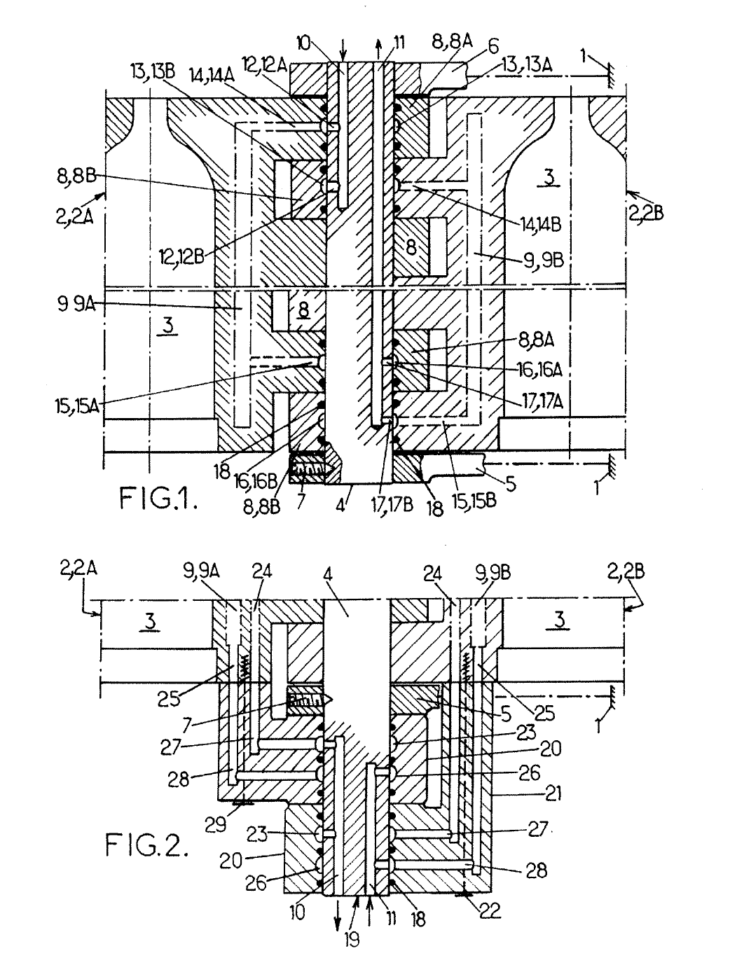

FIG. 1 shows, schematically, a molding device equipped with rotary seals according to a first embodiment of the invention;

FIG. 2 shows, partially and also schematically, a second embodiment of the rotary seals of the molding device according to the invention.

The molding device, represented schematically in FIG. 1, forms part of a mold carrier unit, the frame 1 of which is connected to the carousel, not shown, of a blow-molding or stretch blow-molding machine, with preforms made of thermoplastic material, as described in detail in the above-mentioned US document.

This molding device comprises a mold that is constituted by two half-molds 2, marked 2A and 2B, which each comprise a mold cavity 3 that corresponds to the shape of the container obtained by blow-molding a preform.

This mold is generally constituted by three parts: the two half-molds 2A, 2B and a base mold, or mold base, not shown, which interacts with the two half-molds 2.

These two half-molds 2 are joined together by a rod or shaft 4, this shaft 4 is carried by the frame 1 of the mold carrier unit; it is held in a clevis that comprises two plates 5 and 6 and these plates 5 and 6 are connected to said frame 1.

The shaft 4 is fixed, immobilized, for example, on the plate 5, by any suitable means such as the set screw 7 shown in the figure.

The half-molds 2 comprise bearings 8 that interact with the shaft 4. These bearings 8, marked 8A and 8B for each half-mold 2A and 2B respectively, allow said half-molds to pivot on the shaft 4 between a closed position to allow for the molding of the container and an open position that makes it possible to remove the molded container and position a new preform.

Depending on the container manufacturing method, as described in the above-mentioned US document, each half-mold can comprise means that make it possible to ensure, for example, thermal control of the walls holding the mold cavity 3 of the container.

These means allowing for thermal control are constituted by circuits produced from channels that are bored into the walls of the half-molds 2A and/or 2B.

FIG. 1 shows, schematically, the outline of the circuits 9 that make it possible to introduce a fluid into the corresponding half-mold.

As necessary, only one of the half-molds 2, the half-mold 2A for example, can comprise a circuit 9A for allowing the circulation of a fluid having a thermal control or other function. As mentioned previously, in connection with the above-mentioned US document, the circuit 9A can be used to channel a coolant or be used to feed in compressed air, known as the balancing air supply, at the level of the molding chamber.

For use associated with thermal control, with a coolant, the molding device is equipped with a circuit 9 that is arranged in each of the two walls holding the mold cavity 3 of the container, at the level of each half-mold 2.

These two fluid circuits 9A and 9B are supplied from channels that are bored directly into the shaft 4, axially, and by means of an integrated distribution system.

A first channel 10, which corresponds, for example, to the intake of the fluid, is bored axially into the shaft 4 and its inlet is arranged to be connected to a pipe, not shown, which is itself connected to a supply source that provides the suitable fluid.

This channel 10 can supply the circuit 9A as well as the circuit 9B; this junction between the channel 10 and the circuits 9A and 9B is brought about by a distribution system in the form of rotary seals and these rotary seals are arranged directly in the corresponding bearings 8, i.e. in the bearings 8A and the bearings 8B, respectively.

A second channel 11, also bored axially into the shaft 4, ensures the return of the fluid. This channel 11 is bored into the shaft 4 and its end, at the outlet of said shaft, is arranged to be connected to a return pipe, not shown.

As before, the junction between the circuits 9A, 9B and this channel 11 is brought about by means of the rotary seals that are also arranged in the bearings 8A and 8B of the half-molds 2A and 2B respectively.

In more detail, the communication between the fluid intake channel 10 and the circuit 9, for each half-mold 2, is brought about by means of bores 12 arranged radially in the shaft 4 and of circular grooves 13 arranged opposite said bores 12, in the corresponding bearings 8 of said half-molds 2, and each groove 13 communicates with a channel 14 arranged at the inlet of the circuit 9.

Thus, for the intake of the fluid into the half-mold 2A, the shaft 4 comprises a bore 12A that opens into a groove 13A arranged in one of the corresponding bearings 8A and this groove 13A communicates with a channel 14A that connects it to the inlet of the circuit 9A. Similarly, for the half-mold 2B, the shaft 4 comprises a bore 12B that opens into a groove 13B, which groove 13B is arranged in one of the bearings 8B and communicates with a channel 14B that connects it to the inlet of the circuit 9B.

In the same way, the fluid is returned from the outlet of the circuit 9, for each half-mold 2, by passing through a channel 15 that opens into a groove 16 in the corresponding bearing 8 and this groove 16 communicates with a bore 17, arranged radially in the shaft 4 and which opens into the bore 11 in said shaft 4.

Thus, for the returning of the fluid into the half-mold 2A, there are, successively, the channel 15A, the groove 16A and the bore 17A that opens into the bore 11 in the shaft 4. Similarly, for the half-mold 2B, there are, successively, the channel 15B, the groove 16B and the bore 17B that opens into the bore 11 in the shaft 4.

It is noted that the channel 14 that corresponds to the inlet of the circuit 9, and the channel 15 that corresponds to the outlet, are arranged on the bearings 8 at the ends of each half-mold 2.

Each bearing 8 comprises, on either side of each groove 13, or 16, as applicable, seals 18 of the O-ring type that are associated with a composite friction seal.

This arrangement of the molding device, with a system of rotary seals, makes it possible to limit the number of moving parts. In fact, as the shaft 4 is fixed relative to the frame 1 of the mold carrier unit, this circulation of a fluid in the half-mold(s) 2 is brought about, between the intake and the return of said fluid, in a manner that is internal, i.e. the fluid circulates in the hinge shaft 4 of the half-molds 2 and in these half-molds 2, directly, passing through the bearings 8 of the latter.

FIG. 2 shows a second embodiment of the molding device according to the invention, the walls of which are each equipped with a circuit 9, which is represented in simplified manner, for the circulation of a coolant or other fluid.

These circuits 9 are arranged, as in the above-mentioned U.S. patent, in the wall of each half-mold 2A, 2B and there is a fluid distribution system by rotary seals for supplying each circuit 9. As before, depending on the function of the fluid, a single half-mold 2 can be concerned in this fluid supply.

In this embodiment of FIG. 2, the rotary seals do not directly form part of the half-molds 2. They are assembled on each half-mold 2, and they are arranged on an extension 19 of the shaft 4, which extension extends outside the footprint of the mold as such, outside the space occupied by the half-molds 2 on said shaft 4.

This arrangement provides easy access to the system of rotary seals, without having to dismantle the half-molds 2; it also makes it possible to retain a standard assembly of the half-molds 2 on the shaft 4, with conventional bearings, and in particular bearings with or without lubrication.

The shaft 4 comprises, as illustrated in FIG. 2, an extension 19 that extends beyond the plate 5, for example, and it comprises, arranged in this extension 19, as before, bores 10 and 11 arranged axially. These bores 10 and 11 are provided respectively to receive and return the fluid, whether it is a coolant or other fluid.

Each half-mold, 2A, 2B, is associated with a sort of rotary distributor constituted by these rotary seals, which are located on this extension 19 of the shaft 4, interacting with the channels 10 and 11 provided in this extension 19.

These rotary seals are constituted—by a ring 20 that fits tightly around the extension 19 of the shaft 4 and—by an appendage in the form of arms 21 that ensures the connection between said ring 20 and the corresponding half-mold 2; each arm 21 being fixed to said corresponding half-mold 2 by means of a screw 22, for example.

Each ring 20 comprises two grooves: a groove 23 for the intake of the fluid, which communicates, on the one hand, with the bore 10 in the extension 19 of the shaft 4 and, on the other hand, with the inlet 24 of the circuit 9, and, after the outlet 25 of said circuit 9, each ring 20 comprises a groove 26 for the return, which communicates with the bore 11 in said extension 19 of the shaft 4.

Supplementary channels 27, 28, arranged in the rings 20 and in the arms 21 form the connection between the grooves 23, 26 and, respectively, the inlet 24 and the outlet 25 of the circuit 9 for each half-mold 2 in question.

In the two embodiments shown in FIGS. 1 and 2, the shaft 4 is fixed, connected to the frame 1. The arrangement of this shaft 4, for feeding the inner circuits located in the walls of the half-molds 2, is the same, whether they are half-molds 2 that correspond to a mold of the “book mold” type or to a mold of the “tulip” type as described in document FR 2 912 952.

Moreover, the arrangement of the molding device is not limited to the embodiments shown because, as necessary, a single distributor in the form of rotary seals can be used for the passage of a coolant, or other fluid, depending on its allocated function.

In addition, the two methods of distribution, by rotary seals located in the bearings or by assembled rotary seals, can be combined to increase the possibilities of supplying several coolants or other fluids.

1-3. (canceled)

4. A molding device of the type installed on a frame of a mold carrier unit, which mold carrier unit is positioned on a carousel of a blow-molding or stretch blow-molding machine, which molding device comprises a mold carried by said frame, and including two half-molds joined together by a single shaft on which said half-molds are hinged by means of bearings capable of allowing said half-molds to rotate between a closed position and an open position, and at least one of said half-molds comprises channels that form an inner circuit for the circulation of a fluid, wherein said hinge shaft is mounted fixed relative to said frame of said mold carrier unit and comprises bores provided for receiving and returning said fluid and in that rotary fluid seals that are connected to one of said half-molds with which said rotary fluid seals are associated are mounted on said hinge shaft and interact with said bores to supply said inner circuit.

5. The molding device according to claim 4, wherein said rotary fluid seals are provided directly on said bearings of said half-mold or half-molds.

6. The molding device according to claim 4, wherein said rotary fluid seals are assembled on at least one of said half-molds, which rotary seals are constituted by a ring that is associated by an arm with said at least one half-mold, which ring interacts with an extension of said hinge shaft that extends beyond the footprint of said mold, and said ring with said arm are equipped with channels that respectively connect said bores of said hinge shaft to an inlet and to an outlet of said inner circuit of said half-mold.
